(19) United States
(12) Patent Application Publication
(10) Pub. No.: US 2012/0183164 A1
(43) Pub. Date: Jul. 19, 2012

(54) SOCIAL NETWORK FOR SHARING A HEARING AID SETTING

(75) Inventors: Edwin W. Foo, San Mateo, CA (US); Gregory F. Hughes, Cupertino, CA (US)

(73) Assignee: APPLE INC., Cupertino, CA (US)

(21) Appl. No.: 13/009,746

(22) Filed: Jan. 19, 2011

(51) Int. Cl. H04R 25/00

(52) U.S. Cl. 381/314

(57) ABSTRACT

Broadly speaking, the embodiments disclosed herein describe a social network tailored to meet the needs of individuals having impaired hearing. More specifically the social network provides a mechanism by which members of the social network can communicate with each other information related to improvement the overall quality of life of the members. In a particular embodiment, audio processing characteristics of hearing aids worn by and used by members of the social network can be modified based upon at least some of the information passed between members of the social network.

### FIELD OF THE DESCRIBED EMBODIMENTS

The described embodiments relate to methods and apparatus for processing and/or enhancing audio signals used by a hearing aid. In particular, a social network environment is described that can be used to disseminate information between network members that can be used to modify the operation of a member's hearing aid.

### DESCRIPTION OF THE RELATED ART

A modern hearing aid can help to mitigate at least some of the problems associated with impaired hearing by amplifying ambient sound. A modern hearing aid can receive an input audio signal using an input converter. The audio input signal can in turn be converted into electrical input signals that are routed to a signal processing unit for further processing and amplification. The further processing and amplification can be used to compensate for the individual loss of hearing of a hearing aid wearer. The signal processing unit provides an electrical output signal which is fed via an output converter to the wearer of the hearing aid so the wearer perceives the output signal as an acoustic signal. Earpieces which generate an acoustic output signal are usually used as output converters.

Every electronic hearing aid has at minimum a microphone, a loudspeaker (commonly called a receiver), a battery, and electronic circuitry. The electronic circuitry varies among devices, even if they are the same style. The circuitry falls into three categories based on the type of audio processing (Analog or Digital) and the type of control circuitry (Adjustable or Programmable). In one category, the audio circuit is analog having electronic components that can be adjusted. With these types of hearing aids, a hearing professional (such as an audiologist or certified technician) determines the gain and other specifications required for the wearer, and then adjusts the analog components either with small controls on the hearing aid itself or by having a laboratory build the hearing aid to meet those specifications. After the adjustment is completed, the resulting audio processing does not change any further, other than possibly overall loudness that the wearer adjusts with a volume control. This type of circuitry is generally the least flexible.

In another category, the audio circuit is analog but with additional electronic control circuitry that can be programmed, sometimes with more than one program. The electronic control circuitry can be fixed during manufacturing or in some cases, the hearing professional can use an external computer temporarily connected to the hearing aid to program the additional control circuitry. The wearer can change the program for different listening environments by pressing buttons either on the device itself or on a remote control or in some cases the additional control circuitry operates automatically. This type of circuitry is generally more flexible than simple adjustable controls.

In yet another category, both the audio circuit and the additional control circuits are fully digital in nature. The hearing professional programs the hearing aid with an external computer temporarily connected to the device and can adjust all processing characteristics on an individual basis. Fully digital hearing aids can be programmed with multiple programs that can be invoked by the wearer, or that operate automatically and adaptively. These programs reduce acoustic feedback (whistling), reduce background noise, detect and automatically accommodate different listening environments (loud vs. soft, speech vs. music, quiet vs. noisy, etc.), control additional components such as multiple microphones to improve spatial hearing, transpose frequencies (shift high frequencies that a wearer may not hear to lower frequency regions where hearing may be better), and implement many other features. In some embodiments, the hearing aid wearer has almost complete control over the settings of most, but not all, settings. For example, in order to prevent unintended harm to the wearer, certain settings (such as gain) can only be changed within a well-defined range. Other settings, such a frequency response, can have more latitude but any allowed changes will nonetheless be restricted in order to prevent any changes to the audio processing that may be harmful to the hearing aid wearer.

Fully digital circuitry can also include wireless hearing aids that allow control over wireless transmission capability for both the audio and the control circuitry. Control signals in a hearing aid on one ear can be sent wirelessly to the control circuitry in the hearing aid on the opposite ear to ensure that the audio in both ears is either matched directly or that the audio contains intentional differences that mimic the differences in normal binaural hearing to preserve spatial hearing ability. Audio signals can be sent wirelessly to and from external devices through a separate module, often a small device worn like a pendant and commonly called a “streamer” that allows wireless connection to yet other external devices. In those embodiments where additional computational resources or sensor resources are required, the external devices can take the form of a portable computing device along the lines of a smart phone, tablet device, and portable media player.

Programmable hearing aids that allow a user to adjust the hearing aid response to their own preference have been recently made available at reasonable cost. Using the programmable hearing aid, for example, the frequency response of the hearing aid can be adjusted by the consumer in order to improve the overall user experience by accentuating certain frequencies or range of frequencies. In addition to programmable hearing aids, wireless hearing aids have been developed. For example, for a hearing impaired consumer using two hearing aids, an adjustment to one of the two hearing aids can be transmitted to the other hearing aid such that pressing one hearing aid's program button simultaneously changes the corresponding settings on the other hearing aid such that both hearing aids change settings simultaneously.

Therefore, with the advent of programmable hearing aids whose signal processing can at least be partially modified, what is desired is providing a hearing aid user the ability to modify the audio processing of the programmable hearing aid in the context for which the hearing aid will be used.

### SUMMARY

Broadly speaking, the embodiments disclosed herein describe a social network tailored to meet the needs of individuals having impaired hearing. More specifically the social network provides a mechanism by which members of the social network can communicate with each other information related to improvement of the overall quality of life of the members. In a particular embodiment, audio processing characteristics of hearing aids worn by and used by members of the social network can be modified based upon at least some of the information passed between members of the social network.

In one embodiment, a method for establishing a hearing aid based social network can be performed by carrying out at least the following operations by a local computing device. In the described embodiment, the local computing device is in communication with a hearing aid. The local computing device receives identification of at least one other hearing aid user, presents at least one suggested hearing aid setting at a user interface on the local computing device, receives a selection of a hearing aid setting at the user interface, and communicates the selected hearing aid setting to the at least one other identified hearing aid users.

A method for updating audio processing of a programmable hearing aid in communication with an electronic device is carried out by performing at least the following: identifying a hearing aid setting, the hearing aid setting corresponding to the updated audio processing, requesting a review of the identified hearing aid setting, receiving the review of the requested hearing aid setting when the review is available, requesting the identified hearing aid setting, receiving the requested hearing aid setting, using the received hearing aid setting to update the audio processing of the programmable hearing aid, and processing ambient sound received at the programmable hearing aid in accordance with the updated audio processing.

Non-transitory computer readable medium for storing computer code executable by a processor incorporated in an electronic device for updating audio processing of a programmable hearing aid in communication with the electronic device is described. The computer readable medium includes at least computer code for: identifying a hearing aid setting, the hearing aid setting corresponding to the updated audio processing, requesting a review of the identified hearing aid setting, receiving the review of the requested hearing aid setting when the review is available, requesting the identified hearing aid setting, receiving the requested hearing aid setting, using the received hearing aid setting to update the audio processing of the programmable hearing aid, and processing ambient sound received at the programmable hearing aid in accordance with the updated audio processing.

A hearing aid user social network includes at least a first member and a second member. In one embodiment, the first and second members are in communication with each other by way of a first and second communication device, respectively. The first member is associated with a first member identification that uniquely identifies the first member and the second member is associated with a second member identification that uniquely identifies the second member. The first member requests a selected hearing aid setting from the second member by using a processor in the first communication device to execute the following operations: identifying the selected hearing aid setting, confirming a communication channel between the first communication device and the second communication device, requesting identification of the second member using the communication channel, receiving identification of the second member, forwarding a request for the selected hearing aid setting from the first communication device to the second communication device only when the identification of the second member is confirmed, receiving the selected hearing aid setting, and using the received hearing aid setting to update operations of the hearing aid.

Other aspects and advantages will become apparent from the following detailed description taken in conjunction with the accompanying drawings which illustrate, by way of example, the principles of the invention.

### BRIEF DESCRIPTION OF THE DRAWINGS

The described embodiments will be readily understood by the following detailed description in conjunction with the accompanying drawings, wherein like reference numerals designate like structural elements, and in which:

FIG. 1 shows a representative hearing aid in accordance with the described embodiments.

FIG. 2 illustrates a representative hearing aid (HA) social network in accordance with the described embodiments.

FIG. 3 shows a representation transaction carried out in the HA social network shown in FIG. 2.

FIG. 4 shows a representative peer to peer HA social network in accordance with the described embodiments.

FIG. 5 is a flowchart detailing a process in accordance with the described embodiments.

FIG. 6 is a flowchart detailing a process for requesting and obtaining a HA profile in accordance with the described embodiments.

FIG. 7 is a representative computing system in accordance with the described embodiments.

### DETAILED DESCRIPTION OF THE DESCRIBED EMBODIMENTS

In the following detailed description, numerous specific details are set forth to provide a thorough understanding of the concepts underlying the described embodiments. It will be apparent, however, to one skilled in the art that the described embodiments can be practiced without some or all of these specific details. In other instances, well known process steps have not been described in detail in order to avoid unnecessarily obscuring the underlying concepts.

The audio processing performed by the audio circuitry in a hearing aid can be based upon a number of hearing aid parameters that can be changed by adjusting controls or by programming. Such hearing aid parameters can include frequency response (e.g., signal edge displacement, rise time in the low and high tone range), gain, starting point of AGC, peak clipping, and so forth. For optimal performance, a particular audio environment can have associated with it a particular range of hearing aid parameters that can be further adjusted for the individual user. However, in order to properly adjust the audio processing of the audio circuitry, a potentially large number of hearing aid controls must be adjusted on a real time basis. Since the user can only freely adjust relatively few parameters such as volume or gain, one of the described embodiments utilizes a hearing aid parameter profile, or more simply, HA profile.

In one embodiment, the HA profile can include a set of parameters that can represent the context of the environment for which the HA profile is associated. The HA profile can be selected by the individual user to adjust the processing carried out by the audio circuitry on the audible sounds received from the external acoustic environment. In one embodiment, the HA profile can include a range of hearing aid parameters specific to the individual user. The parameters can be established by an audio technician under the guidance of a certified audiologist (or by the audiologist directly). The HA profile can then be programmed into the hearing aid and be used to adjust the processing of external audio by the audio circuitry in the hearing aid.

In one embodiment, a number of different HA profiles can be available based upon, for example, the acoustics of the immediate surroundings of the hearing aid user. For example, a first HA profile can be used for processing external audio emanating from a generally quiet background environment such as a library, whereas a second HA profile can be used to process external audio emanating from a noisy environment such as a rock concert. In one embodiment, the hearing aid wearer can use an image capture device, such a camera, included in a portable device, such as a smartphone, to capture an image of the immediate surroundings. The captured image can then be used to estimate an acoustic environment based upon, for example, the nature of the immediate surroundings (indoor, outdoor, for example) and, if indoor, the dimensions of the room in which the hearing aid wearer is located.

In one embodiment, the hearing aid profile can be stored in a nearby computing device such as a personal computer. The HA profile can be transferred from the personal computer to the hearing aid wirelessly or by way of a wired connection. In one embodiment, at least portions of the HA profile can be adjusted in real time to accommodate a new or modified external environment. For example, the adjustment of the HA profile can be based upon information received from a social network of hearing aid users. The social network of hearing aid users can pass information amongst themselves. The information can include suggested hearing aid settings for a specific venue. For example, a first member of the HA social network can identify at least another, second, member of the HA social network. The first member can opt to send the second member suggested HA setting(s) based upon an experience at a specific venue, such as a rock concert. The second member can use the suggested HA setting to modify an HA profile that can then be used when the second member enters the specific venue. This information can then be used to modify an existing HA profile or retrieve an existing HA profile that can, in turn, be used to replace or in some cases adapt a currently used HA profile. In one embodiment, the HA profiles can be locally stored at the hearing aid. In one embodiment, the HA profiles can be stored at a nearby computing device that can take the form of a desktop computer such as an iMac™ , a laptop computer such as a MacBook Pro™ or personal communication device, or PCD, such as an iPod™, or a smartphone such as the iPhone™ all of which are manufactured by Apple Inc. of Cupertino, Calif.

In any case, the personal communication device can be configured to wirelessly receive and in most cases send a signal that can contain information related to an HA profile or a specific HA setting within an HA profile. More specifically, the information can be directed at updating an existing HA setting within the HA profile, providing a new HA setting, providing a user review of an HA profile and so on. When configured for use in a wireless environment, the information can be broadcasted by one or more personal communication devices to other devices that are within the transmission range of the broadcasting device(s).

However, if broadcasting the information from one device to a number of different devices is not appropriate or feasible, an ad hoc peer to peer (P2P) network can be formed using those personal communication devices capable of acting as a node. In this way, a first one of the personal communication devices can be used to seed the P2P network by, for example, wirelessly transmitting a signal that can include an identifier. The identifier can be used to provide identification of a personal communication device. For example, a first personal communication device can use a wireless protocol and wirelessly transmit a signal that can include the identifier and/or information related to an HA setting or HA profile. Devices within the transmission range of the first personal communication device (BlueTooth™ is about 10 m, or 30 feet) capable of receiving and processing the signal can retrieve the information.

The information can be further propagated within the P2P network by retransmitting the information in the signal to other personal communication devices within range of the sending device. In this way, each personal communication device properly configured for participation in the peer to peer network can share the same information.

In addition to or in place of the peer to peer HA social network, any member of the HA social network can post suggested HA settings on a server computer. The server computer can then, if desired, act as a web server and post a communal web site. In this way, members of the HA social network having access to the communal web site can view a suggested HA setting for specific venues or events. In yet another embodiment, an online service provider, such as a ticketing agent, can post some of the suggested HA settings for each event posted on the ticketing agent website. The HA settings posted at the ticketing agent website can include specific HA profiles created by, for example, a certified technician or audiologist for various types of hearing aids and even types of hearing loss. For example, in one embodiment, an individual can log onto the ticketing agent website and provide specific information related to the model of hearing aid currently being used. In some cases the information can also provide an indication of the type of hearing loss (high frequency deficit, low frequency deficit, or some combination). In this way, the information can be used to identify the certified HA profile that is deemed optimal for the individual while in attendance at the event.

It should be noted however, that it is contemplated that the HA profile acquired from the website is in the form of an overlay. As an overlay, the acquired HA profile does not typically supplant the user's HA profile, but adds to it in a non-destructive (i.e., does not permanently replace) manner. For example, if the user's base HA profile includes a frequency response curve that accentuates high frequencies (to compensate for age related high frequency hearing loss, for example), the HA profile overlay will augment the existing frequency response curve by, for example, accentuating certain frequencies or frequency bands within the range of accentuated high frequencies.

It should be noted that members of the HA social network can communicate with each other directly by using any suitable communication protocol. For example, in one embodiment, at least two members of the HA network can communicate with each other over a wireless communication channel using a suitable wireless communication protocol such as Bluetooth (BT), WiFi, and so on. The communication channel can also take the form of a wired communication channel or a combination of both wireless and wired communication channels. In one embodiment, the hearing aid itself can use any available communication channel to communicate with other computing devices. For example, the hearing aid can wirelessly communicate with a portable personal computing device such as the iPod™, iPhone™, iPad™, and so on, each of which is manufactured by Apple Inc. of Cupertino, Calif.

Using the iPhone™ as an example, a data link can be established between a web server that provides web services for the HA social network and the iPhone™ In this way, the iPhone™ can display a user interface that can be used to select specific HA profiles (or overlays) associated with a particular venue. The user can then download the selected HA profile (or overlay) that can then be used to update the HA profile currently being used by the user's hearing aid. In one embodiment, the user can choose to continue to use the selected HA profile (or overlay) or decide to select and download another HA profile (based, for example, on subjective considerations). In some embodiments, the user can review the selected HA profile (or overlay) and post the review back to the web server for posting on the HA social network website for other members to view and consider.

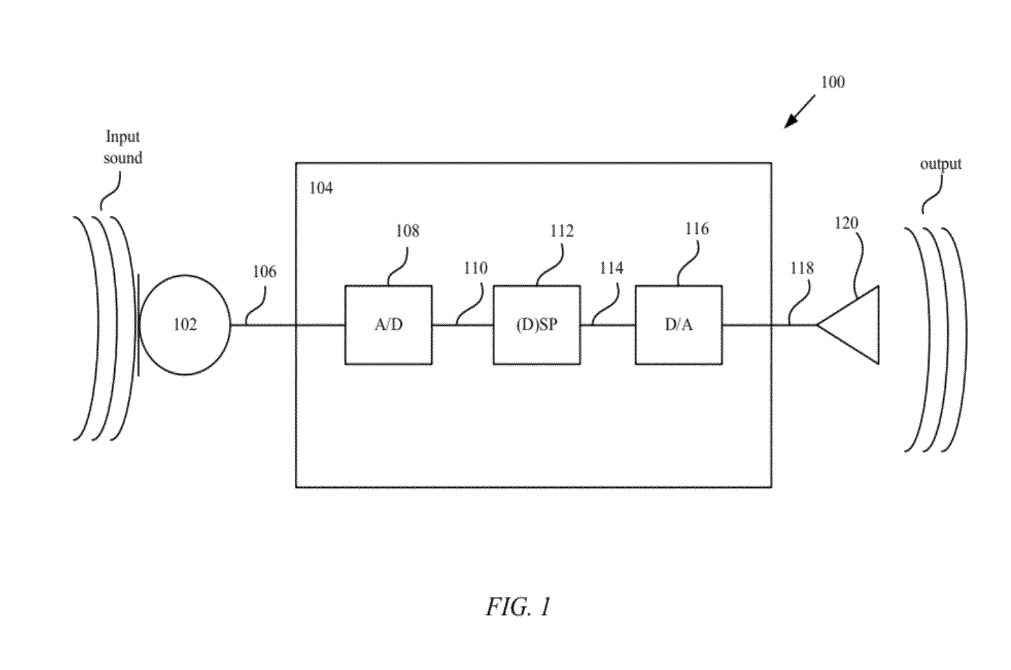

These and other embodiments are discussed below with reference to FIGS. 1-7. However, those skilled in the art will readily appreciate that the detailed description given herein with respect to these figures is for explanatory purposes as the invention extends beyond these limited embodiments. For the remainder of this discussion, it is presumed that a hearing aid wearer has great latitude in modifying all or at least most HA settings. At no point, however, should it be construed that the hearing aid wearer is in any way supplanting or otherwise acting in the guise of a medical professional.

FIG. 1 is a block schematic showing hearing aid 100 in accordance with the described embodiments. Hearing aid 100 can include at least audio sensor 102 arranged to detect acoustic energy that can take the form of sound. In one embodiment, audio sensor 102 can take the form of (one or more) microphone 102 connected to an input node of audio processing circuitry 104. Microphone 102 can use, for example, a vibrating membrane that can mechanically respond to sound waves impinging on its surface. The vibrating membrane can interact with a transducer (not shown) to create electrical signal 106 that is analogous (i.e., analog) to the detected sound waves.

Analog signal 106 can be passed to audio processing circuitry 104 for processing. It should be noted that audio processing circuitry 104 can be totally analog in nature, whereas in other embodiments, audio processing circuitry 104 can have some components that are analog while other components are digital. However for the remainder of this discussion and without loss of generality, audio processing circuitry 104 will be considered as being fully digital in nature. Therefore, digital audio processing circuitry 104 can include analog to digital (A/D) converter unit 108 arranged to receive analog signal 106 generated by microphone 102. A/D converter unit 108 converts analog signal 106 into digital signal 110 using any suitable digitization process. For example, A/D converter unit 108 can periodically sample analog signal 106, the sampled value of analog signal 106 being used to form digital signal 110.

In one embodiment, an output node of A/D converter unit 108 can be connected to (digital) signal processor 112. DSP 112 can include at least additional signal processing circuits (not shown) for filtering, compressing and amplifying input digital signal 110 to form output digital signal 114 at an output node of DSP 112 that can, in turn, be connected to an input node of a digital/analog (D/A) converter 116. D/A converter 116 can convert digital signal 114 into a corresponding analog signal 118 at an output node of D/A converter 116 that can be connected to and be used to drive output transducer 120. It should be noted, however, that in an alternative embodiment, DSP 112 can be configured in such a way to drive output transducer 120 directly without requiring D/A converter 116.

It should be noted that output 120 can take many forms depending upon the nature of hearing aid 100. For example, in one embodiment, output 120 can take the form of an acoustic transducer arranged to provide acoustic output in the form of sound waves. The acoustic output can then be transmitted in a conventional manner to the hearing aid user's auditory system. In one embodiment, output 120 can be used to stimulate nerves in the hearing aid user's auditory system. In one embodiment, output 120 can be implanted into a bone near the hearing aid user's auditory system. In this way, electrical energy generated by output 120 can be transmitted through the bone and be used to stimulate certain auditory nerves. This type of hearing aid is generally described in terms of a cochlear implant.

In one embodiment, DSP 112 can be programmable by which it is meant that the audio processing carried out by DSP 112 can be widely varied. For example, DSP 112 can be programmed according to a hearing aid profile that can include a plurality of settings each of which can alter a corresponding audio processing operation. For example, the settings can include various frequency response curves (along the lines of an equalizer), gain control, filtering such as notch or band pass filtering and the like. In this way, hearing aid 100 can adapt its signal processing to a wide number of variables such as the environmental (i.e., ambient) noise level, room acoustic characteristics, user provided changes to parameters and so on.

In one embodiment, a hearing aid profile can include a set of rules relating to speech intelligibility implemented in DSP 112 that can be used to optimize the signal processing by, for example, reducing or even merely characterizing ambient noise based on an analysis carried out by DSP 112. In one embodiment the signal processing can be used to improve overall signal reproduction to benefit intelligibility of speech in the reproduced audio signal. These rules are preferably based on the theory of the speech intelligibility index, but may be adapted to other beneficial parameters relating to audio reproduction in alternative embodiments.

Furthermore, in an alternative embodiment, parameters other than the individual frequency band gain values can be incorporated as output control parameters. These values can, for example, be attack or release times for gain adjustments, compression ratio, noise reduction parameters, microphone directivity, listening program, frequency shaping, and other parameters. Alternative embodiments that incorporate several of these parameters can easily be implemented, and the selection of which parameters will be affected by the analysis may be applied by the hearing aid provider at the time of fitting the hearing aid to the individual user, or subsequent to the fitting, using any number of techniques described herein.

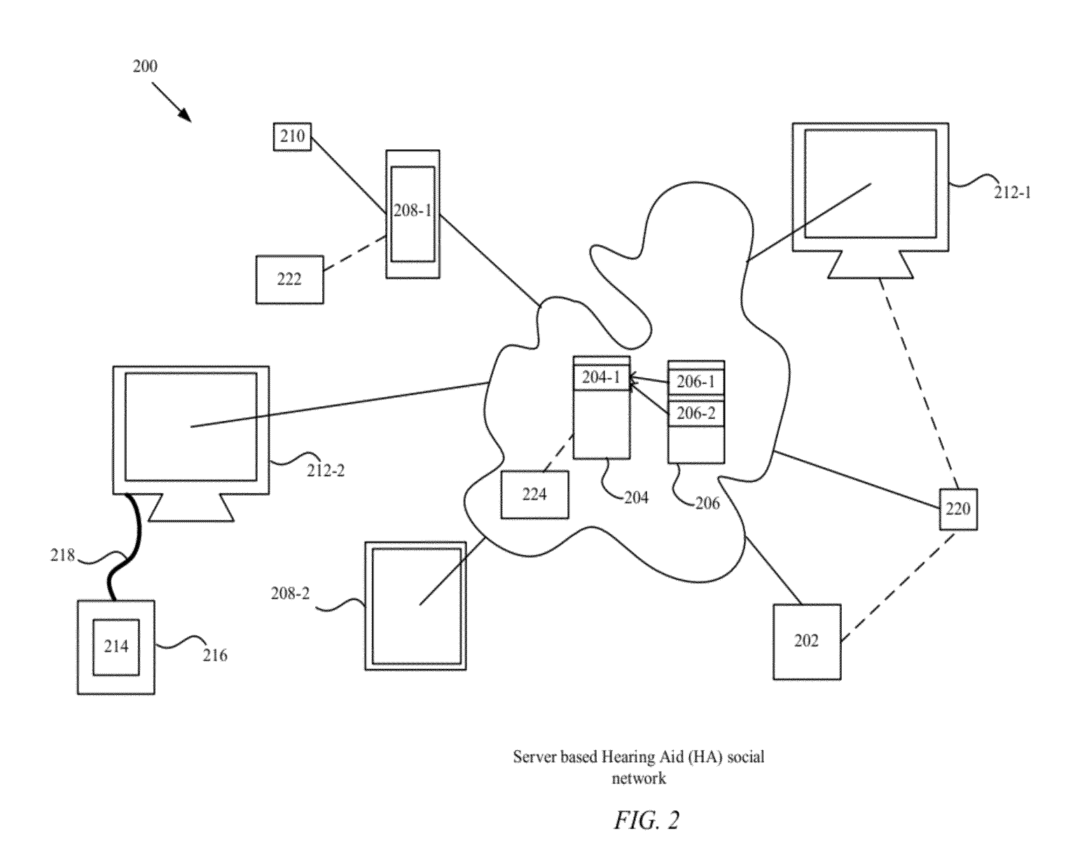

FIG. 2 is a block diagram of a server based hearing aid (HA) social network 200 according to one embodiment. HA social network 200 can refer to one or more data networks, typically, high data-bandwidth networks, namely, wired networks, such as the Internet, Ethernet, gigabit Ethernet, and fiber optic, as well as wireless networks such as IEEE 802.11(a) . . . (n) or (“x”) (WiFi), IEEE 802.16 (WiMax), and Ultra-Wide Band (UWB). HA social network 200 can include server 202. Server 202 can coordinate acquisition of a hearing aid (HA) profile from HA profile database 204 through on-line transactions. In one embodiment, HA profile review database 206 can include a plurality of HA profile reviews each associated with a particular HA profile. For example, HA profile reviews 206-1 and 206-2 can each be associated with HA profile 204-1. Server 202 can retrieve either or both HA profile reviews 206-1, 206-2 as requested by a user. The request can be used to evaluate whether or not the user will retrieve HA profile 204-1. For example, if HA profile 204-1 has negative reviews or is reviewed in a light that the user does not find positive, then the user can choose to not retrieve HA profile 204-1. On the other hand, the user can scan HA profile review database 206 for favorable reviews and choose to retrieve the HA profile associated with the most favorable reviews.

Accordingly, the HA profile review can provide subjective user feedback about a particular HA profile. For example, a user can provide a subjective summary of the user's experience of how a particular HA profile affected the audio processing of the user's hearing aid at a particular context, such as a rock concert. The user can then relate that experience (either subjectively or objectively) in the form of an associated HA review. The HA review can then be uploaded to HA review database 206 by way of server 202. In one embodiment, the uploaded HA review can be tagged with metadata that points the HA review to a particular HA profile and in some cases to specific venue or context of use of the reviewed HA profile.

In one embodiment, the HA review can be identified with a particular HA profile and in some embodiments, an associated venue. In one embodiment, the HA review can include a user's subjective rating of a particular HA profile, the context for which the rating was given, and any suggestions how the HA profile can be improved, if at all. A user can read reviews and ratings for a particular HA profile prior to being retrieved by the user. In this way, the user can have some idea of what to expect when the particular HA profile is used in the context for which it was reviewed. In one embodiment, the user can be provided with the opportunity to provide a subjective evaluation of the accuracy of the posted HA review based upon their own subjective experience.

HA social network 200 can also include a number of members. In some instances, at least some of the members of HA social network 200 can be associated with a client device. The client device can provide the associated member with access to information provided by HA social network 200 as well as other members. The client device can take many forms. For example, in one embodiment, the client device can take the form of a personal communication device PCD 208 along the lines of smartphone 208-1. In one embodiment, smartphone 208-1 can be in wireless communication with hearing aid 210. The client device can also take the form of tablet device 208-2. In one embodiment, the client device can be a desk top computer or embedded computing resource. Accordingly, the client device can take the form of remote desktop computer 212-1 or local desktop computer 212-2 in wired communication with hearing aid 214 by way of dock 216 using cable 218. For example, hearing aid 214 can be placed within dock 216 that can be connected to desktop computer 212-2 by way of wired connector 218.

In some cases, the hearing aid itself can communicate with other hearing aids or client devices as well as server 202. In one embodiment the communication can be carried out using wireless signals. For example, wireless hearing aid 220 can wireles sly communicate directly with server 202 without the requiring an intervening device. Wireless hearing aid 220 can also wirelessly communicate with remote computing resources outside of server based HA social network 200 using an ad hoc peer to peer type arrangement discussed in more detail below. For example, as part of the ad hoc peer to peer network, wireless hearing aid 220 can communicate with remote desktop computer 212-1 bypassing server 202. In this case, therefore, all necessary computing resources such as processor and memory resources can be found within hearing aid 220.

In one embodiment, computer program 222 configured as a hearing aid profile management application (HAPMA) can run on any client device. HAPMA 222 can be used by a member of HA social network 200 for a variety of purposes, including, but not limited to: (i) browsing and/or purchasing (if allowed) digital assets (including HA profiles, reviews, and so on) from server 202. In some cases, server 202 can host an online store that can provide HA profiles, reviews, and such for a price, (ii) creating and sharing HA profiles and/or profile overlays, (iii) organizing HA profiles, (iv) presenting HA profiles, and/or (v) transferring HA profiles, reviews and such between client devices 208/212. In an alternative embodiment, HAPMA 222 can be a network browser application (e.g., web browser).

HA social network 200 can also include HA profile manager 224 that can be coupled to HA profile database 204 used to store both HA profiles and associated HA profile information. The HA profile information can include metadata relating to an HA profile and associated assets such as pointers to reviews available for download. The HA profiles can also be purchased for download at the online HA profile store or can be provided without cost. In one embodiment, HA profile manager 224 can control the amount and kind of HA profile information available to HA social network 200.

HA profile manager 224 can enable the user of a particular client device to acquire (or purchase if a cost is associated with the HA profile) a set (e.g., group or collection) of HA profiles through on-line transactions. In one type of transaction, the user can purchase or otherwise acquire one or more HA profiles associated with, for example, a particular venue such as a rock concert. The user can then use the downloaded HA profiles to modify the audio processing of hearing aid 210. In one embodiment, HA profiles can be retrieved at an event or venue such as a rock concert. The HA profile can then be used in real time and evaluated in the actual environment or context of use for which it is intended. In this way, the individual user can subjectively evaluate each HA profile in actual use. The member can create a review based upon the subjective experience of the member at the event or venue. The member can then post the review or commentary in HA review database 206. In some cases, the user can modify the acquired HA profile based upon the subjective experience of the user. The modified HA profile can then be made available for use by other members of HA social network 200.

As will be understood by those familiar with data networks, other network configurations are possible. Furthermore, while HA social network 200 and server 202 are shown as individual and separate devices, it will be understood by those familiar with the art that other configurations are possible. As one example, each device can be implemented such that it is distributed over multiple server computers. As another example, these various servers and/or managers can be implemented by a single physical server computer.

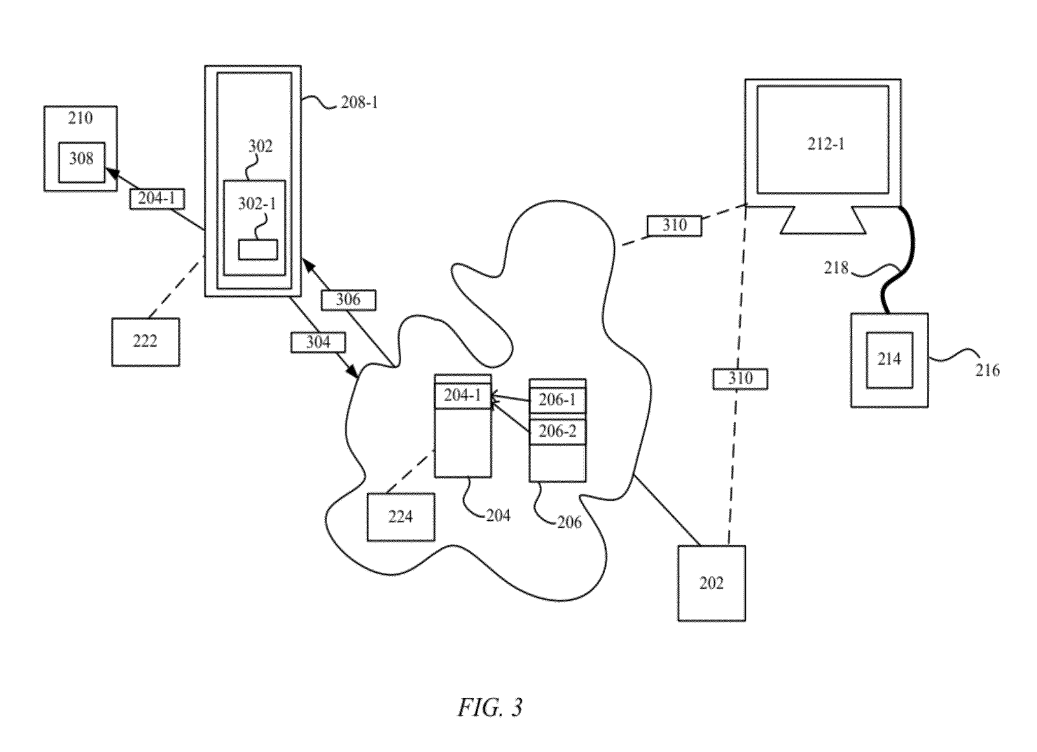

Since hearing aid 210 (and 220 for that matter) is presumed to be programmable, the operations of hearing aid 210 can be modified in such a way to process externally generated sound in accordance with one of the HA profiles stored in HA profile database 204. For example, HA profile 204-1 can be downloaded from HA profiles database 204 by a member of HA social network 200 as shown in FIG. 3 In one embodiment, PCD 208-1 can provide graphical user interface (GUI) 302 to assist the member in identifying a particular one of the HA profiles in HA profile database 204. GUI 302 can present graphical icons, video, text, or in some instances, audio snippets that can be used by the member to identify a particular HA profile.

Once the member has identified the HA profile for download, in one embodiment, the member can request if there are any reviews for the identified HA profile in HA profile review database 206. If a review, or reviews is determined to be available, then the member has the option of using the review(s) to determine if in fact the identified HA profile is suitable for the context in which it will be used. If the member determines that the identified HA profile is not suitable, then the member can request another review of another HA profile. In one embodiment, the member can query favorable reviews first and then based upon the HA profile with the most frequent or most relevant reviews can be selected.

As shown in FIG. 3, once the member has identified the HA profile, the member can use selection icon 302-1 presented by GUI 302 to select the identified HA profile. In those cases where GUI 302 is touch sensitive, the member can touch at or near selection icon 302-1 to instantiate selection request 304. Selection request 304 can include information in the form of metadata that can be used to identify and retrieve identified HA profile 204-1 in the form of response 306. Response 306 can include HA profile 204-1 or in some cases, only those settings in HA 204-1 that differ from an HA profile currently stored in memory 308 of hearing aid 210. In this way, the possibility of modifying the audio processing carried out by hearing aid 210 beyond a safety threshold can be effectively prevented.

HA profile 204-1 can be uploaded to PCD 208-1. In one embodiment, HA profile 204-1 can be stored locally at PCD 208-1. In another embodiment, PCD 208-1 can pass all or only part of HA profile 204-1 directly to hearing aid 210 for storage in memory 308. In one embodiment HA profile 204-1 can overlay portions of the current HA profile. In another embodiment, however, HA profile 204-1 can effectively replace the current HA profile in memory 308.

It should be noted that at no point is it contemplated that a lay person will be allowed to create a complete, or even nearly complete, HA profile without the direct intervention of a qualified practitioner such as an audiologist or, at the minimum, a certified technician under the supervision of the audiologist. Accordingly, in one embodiment, remote computer 212-1 can be used by the audiologist or certified technician to create an HA profile based upon the results of various hearing evaluation tests. Results of the hearing evaluation tests can be used in part to develop new or at least substantially revised HA profile 310. HA profile 310 can be stored locally at client computer 212-1 for later uploading to server 202. In one embodiment, HA profile 310 can be provided to hearing aid 208 by way of a direct connection (along the lines of dock 216) or by way of a wireless LAN (such as in the audiologist's office), or even uploaded to server 202 for secure transfer to the patient via a secure transaction along the lines described above.

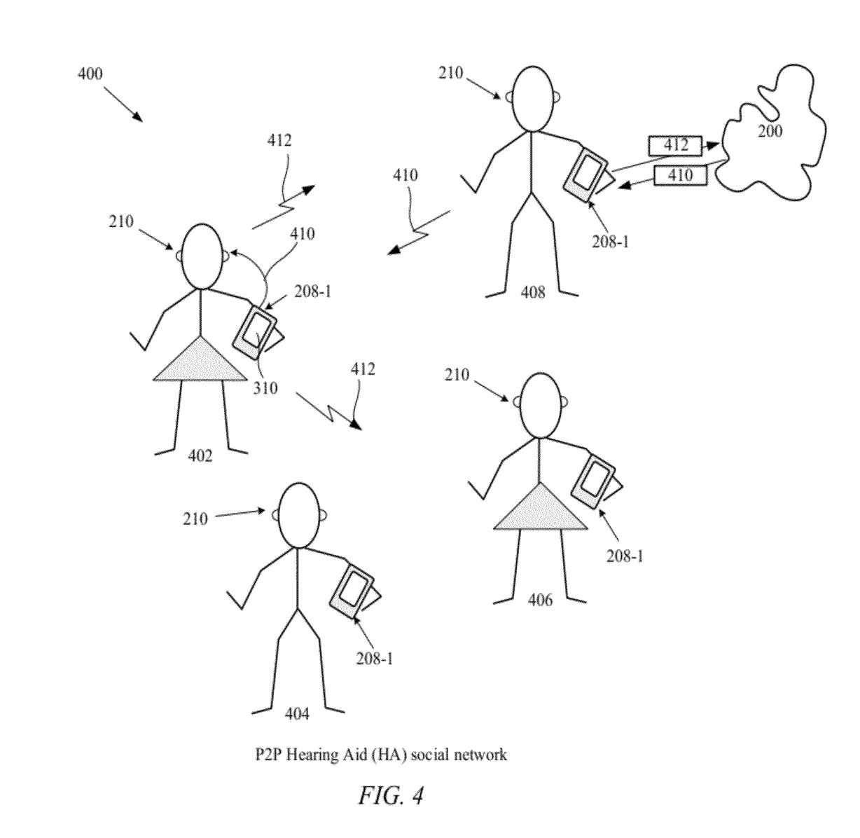

In addition to or in place of server based HA social network 200, FIG. 4 shows representative ad hoc peer to peer HA social network 400. It should be noted that devices within server based HA social network 200 can form an ad hoc peer to peer HA social network along the lines shown in FIG. 4. For example, when at home, information related to a specific event or venue can be retrieved using server based HA social network by way of a web page accessed on a home computing system. However, once the user has left home, ad hoc peer to peer HA social network 400 can be used to retrieve updated information, download HA settings or profiles and so on.

As shown in FIG. 4, members 402-408 of group peer to peer HA social network 400 can communicate with each other by way of associated personal communication devices, or PCDs. Each of members 402-408 can use their respective PCD to pass information to each of the other members of peer to peer HA social network 400. The information can include at least requests for HA information such as HA profiles and HA settings. The requests can be for specific HA profiles, HA settings, HA reviews, recommendations for specific venues, events, places of business and so forth. The responses can be provided directly from the responsive member or can be relayed to a data repository such as HA profile database 204 by way of server 202 (illustrating a combination of peer to peer and server based HA social networking).

For example, member 402 can use GUI 310 presented on PCD 208-1 to request HA profile 410 from members of peer to peer network 400. In one embodiment, member 402 can broadcast request 412 that can be received by any member within range (which for BlueTooth™ is about 10 meters). Any member receiving request 412 can respond by, for example, providing HA profile 410 from their respective PCD. In another embodiment, member 402 can receive information from, for example, member 408. The information can include identification information attesting to the veracity of any forthcoming response by member 408. In this way, member 402 can receive information from member 408 confident of its accuracy.

In one embodiment, member 408 can forward request 412 to server based network 200 for servicing. In this way, although member 408 does not currently possess the information requested by member 402, member 408 can nonetheless acquire the requested information from, for example, HA profile database 204. The information in the form of HA profile 410 can then be relayed back to member 402. Member 402 can then use GUI 302-1 (shown in FIG. 3) to load HA 410 to hearing aid 210 along the lines already described.

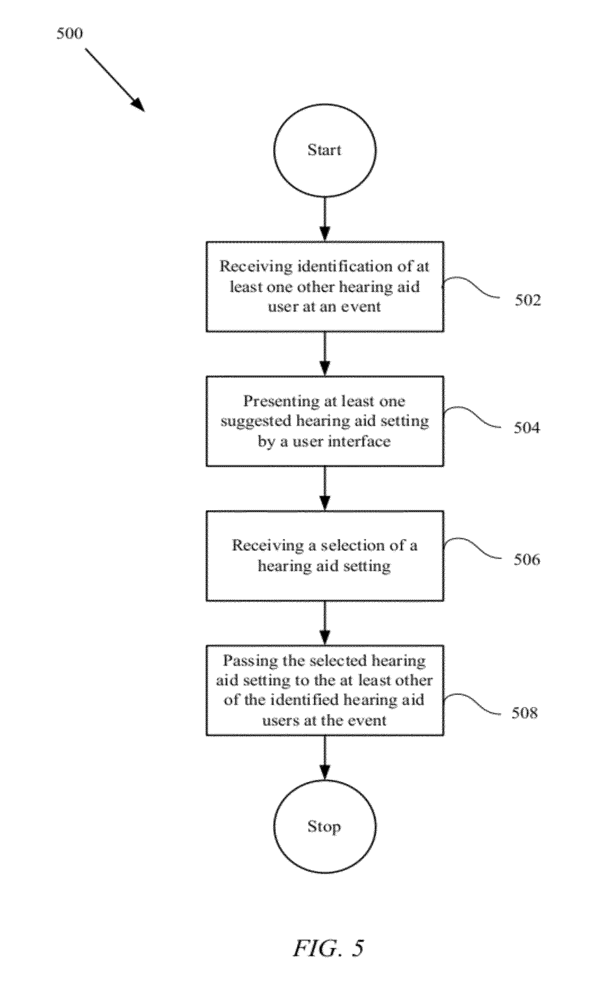

FIG. 5 shows a flowchart detailing process 500 in accordance with the described embodiments. Process 500 can be used to retrieve information such as an HA profile or specific HA settings within a particular profile. Process 500 can be performed over server based HA network 200 or peer to peer HA network 400 or any combination. Process 500 can be performed by a computing system such as a personal computing device. The personal computing device can include client devices such as a smartphone, tablet device, as well as a desktop computer.

Process 500 can begin at 502 by receiving information from at least one other hearing aid user as a member of the HA social network. In one embodiment, the information can include identification information providing the identity of the at least one other member. The identification information can be used to confirm the veracity of any information provided. At 504, at least one suggested hearing aid setting is presented by the personal computing device. In one embodiment, the hearing aid setting can be presented at a user interface presented at a display, the display incorporated in the personal computing device. Next, at 506, a user selection of a hearing aid setting is received at the GUI and processed by the personal computing device. At 508, the selected hearing aid setting is then passed to the identified other member. In one embodiment, the identified other member can be located at an event for which the requested hearing aid setting is intended for use. In another embodiment, the other member can also request a review or reviews associated with the requested hearing aid setting.

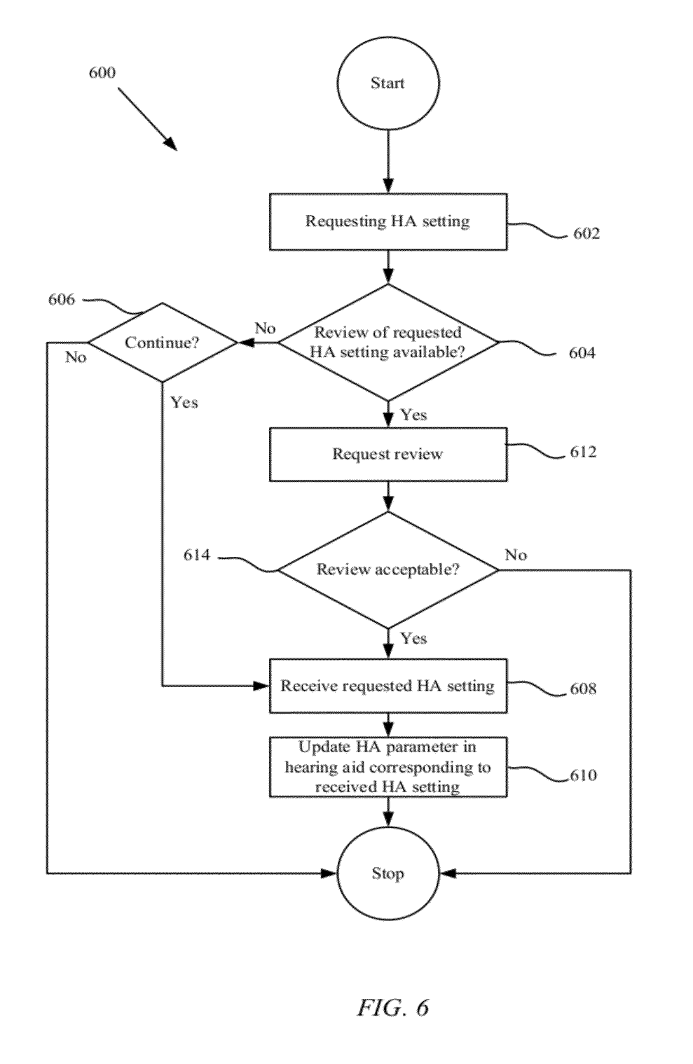

FIG. 6 shows a flowchart detailing an HA setting transaction process 600 in accordance with the described embodiments. Process 600 can be used by a member of a HA social network to retrieve an HA setting, or in some embodiments, a full HA profile. The transaction can involve elements of a P2P type HA social network and elements of a server type HA social network used separately or in cooperation with each other.

In any case, process 600 is performed at a computing device. The computing device can be portable in nature such as a PCD or can be essentially statically located along the lines of a desktop. In any case, process 600 can begin at 602 by requesting an HA setting. The requested HA setting can be intended to modify at least an operating characteristic of a hearing aid. The operating characteristic can include at least audio processing performed by audio processing circuitry included in the hearing aid. The changes can be intended for use in a particular event or venue, such as a rock concert, or can be just to “try out” a new or different HA setting. In any case, if it is determined at 604 that a review of the requested HA setting is not available, then at 606, if the requestor decides to not go forward with retrieving the requested HA setting, then process 600 can end. On the other hand, if at 606 the requestor decides to go forward without a review, then at 608 the requested HA setting is received and used to update an HA parameter (or profile) in the requestor's hearing aid corresponding to the received HA setting at 610.

Returning to 604, if it is determined that a review is available for the requested HA setting, then at 612 the available review (or reviews) is requested. At 614, if the requestor determines that the review(s) is not acceptable, then processing ends, otherwise, control is passed to 608 where the requested HA setting is received at 608 and used at 610 to update current settings (or profile) in the requestor's hearing aid.

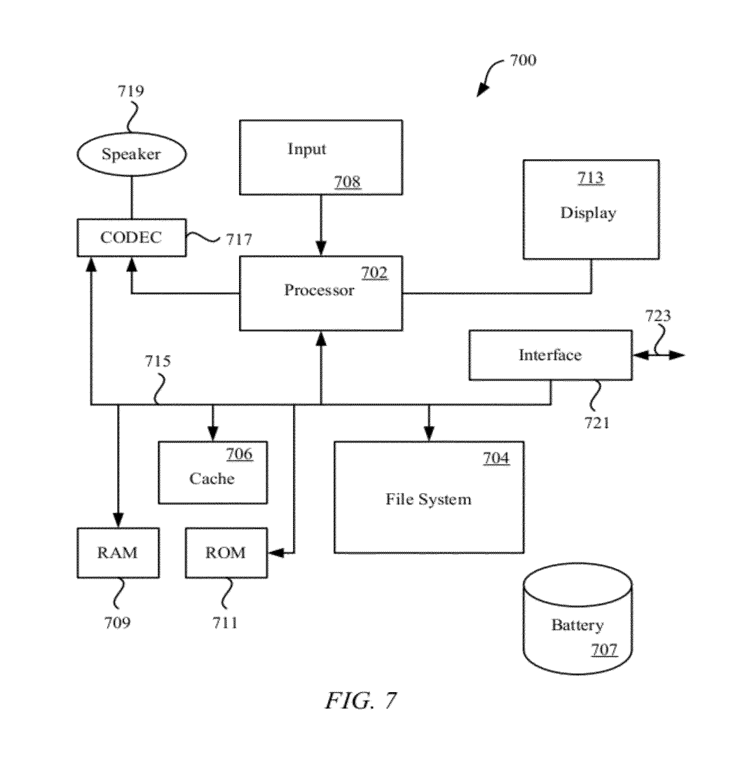

FIG. 7 is a block diagram of an electronic device 700 suitable for use with the described embodiments. The electronic device 700 illustrates circuitry of a representative computing device. The electronic device 700 includes a processor 702 that pertains to a microprocessor or controller for controlling the overall operation of the electronic device 700. The electronic device 700 stores media data pertaining to media items in a file system 704 and a cache 706. The file system 704 is, typically, a storage disk or a plurality of disks. The file system 704 typically provides high capacity storage capability for the electronic device 700. However, since the access time to the file system 704 is relatively slow, the electronic device 700 can also include a cache 706. The cache 706 is, for example, Random-Access Memory (RAM) provided by semiconductor memory. The relative access time to the cache 706 is substantially shorter than for the file system 704. However, the cache 706 does not have the large storage capacity of the file system 704. Further, the file system 704, when active, consumes more power than does the cache 706. The power consumption is often a concern when the electronic device 700 is a portable media device that is powered by a battery 707. The electronic device 700 can also include a RAM 709 and a Read-Only Memory (ROM) 711. The ROM 711 can store programs, utilities or processes to be executed in a non-volatile manner. The RAM 709 provides volatile data storage, such as for the cache 706.

The electronic device 700 also includes a user input device 708 that allows a user of the electronic device 700 to interact with the electronic device 700. For example, the user input device 708 can take a variety of forms, such as a button, keypad, dial, touch screen, audio input interface, visual/image capture input interface, input in the form of sensor data, etc. Still further, the electronic device 700 includes a display 713 (screen display) that can be controlled by the processor 702 to display information to the user. A data bus 715 can facilitate data transfer between at least the file system 704, the cache 706, the processor 702, and the CODEC 717.

In one embodiment, the electronic device 700 serves to store a plurality of media items (e.g., songs, podcasts, etc.) in the file system 704. When a user desires to have the electronic device play a particular media item, a list of available media items is displayed on the display 713. Then, using the user input device 708, a user can select one of the available media items. The processor 702, upon receiving a selection of a particular media item, supplies the media data (e.g., audio file) for the particular media item to a coder/decoder (CODEC) 717. The CODEC 717 then produces analog output signals for a speaker 719. The speaker 719 can be a speaker internal to the electronic device 700 or external to the electronic device 700. For example, headphones or earphones that connect to the electronic device 700 would be considered an external speaker.

The electronic device 700 also includes a network/bus interface 721 that couples to a data link 723. The data link 723 allows the electronic device 700 to couple to a host computer or to accessory devices. The data link 723 can be provided over a wired connection or a wireless connection. In the case of a wireless connection, the network/bus interface 721 can include a wireless transceiver. The media items (media assets) can pertain to one or more different types of media content. In one embodiment, the media items are audio tracks (e.g., songs, audio books, and podcasts). In another embodiment, the media items are images (e.g., photos). However, in other embodiments, the media items can be any combination of audio, graphical or visual content.

The various aspects, embodiments, implementations or features of the described embodiments can be used separately or in any combination. Various aspects of the described embodiments can be implemented by software, hardware or a combination of hardware and software. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for establishing a hearing aid based social network, comprising:
by a local computing device in electronic communication with a local hearing aid,
receiving identification of at least one other hearing aid user;
presenting at least one suggested hearing aid setting at a user interface on the local computing device;
receiving a selection of a hearing aid setting at the user interface; and
communicating the selected hearing aid setting to the at least one other identified hearing aid users.

2. The method as recited in claim 1, further comprising:
sending a request for a hearing aid setting to the identified hearing aid user.

3. The method as recited in claim 1, further comprising:
receiving the requested hearing aid setting from the at least one other identified hearing aid user; and
using the requested hearing aid setting to adjust an operation of the local hearing aid.

4. The method as recited in claim 1, wherein the local hearing aid is located at an event.

5. The method as recited in claim 4, wherein the received hearing aid setting is event based.

6. The method as recited in claim 5, further comprising:
processing ambient audio sound by the local hearing aid in accordance with the event based hearing aid setting;
evaluating the processed audio sound by a user of the local hearing aid;
generating a review of the updated hearing aid setting based upon the evaluation; and
enabling the review to be read by at least one other member of the hearing aid social network.

7. The method as recited in claim 6, further comprising:
associating the event based hearing aid profile setting with an event based hearing aid profile.

8. A method for updating audio processing of a programmable hearing aid in communication with an electronic device, comprising:
identifying a hearing aid setting, the hearing aid setting corresponding to the updated audio processing;
requesting a review of the identified hearing aid setting;
receiving the review of the requested hearing aid setting when the review is available;
requesting the identified hearing aid setting;
receiving the requested hearing aid setting;
using the received hearing aid setting to update the audio processing of the programmable hearing aid; and
processing ambient sound received at the programmable hearing aid in accordance with the updated audio processing.

9. The method as recited in claim 8, wherein the electronic device is a portable communication device in wireless communication with the programmable hearing aid.

10. The method as recited in claim 9, further comprising:
presenting a user interface comprising at least a user selectable icon associated with at least one hearing aid setting at a display of the portable communication device;
receiving a selection event at the user selectable icon; and
using the selection event to identify the hearing aid setting.

11. The method as recited in claim 9, wherein the received review includes at least a commentary portion and a rating portion each provided by a previous user of the hearing aid setting, and wherein the hearing aid setting is requested only when the received review indicates that the updated hearing aid setting is acceptable based upon the commentary portion and the rating portion.

12. The method as recited in claim 11, further comprising:
receiving an external audio signal at an input transducer of the programmable hearing aid;
processing the external audio signal by a signal processor in accordance with the updated audio processing; and
outputting the processed external audio signal as an output signal.

13. The method as recited in claim 9, further comprising:
evaluating the output signal by a current user of the hearing aid;
providing a current review of the received hearing aid setting based upon the evaluation; and
providing the current review to at least one other hearing aid user in communication with the current hearing aid user.

14. Non-transitory computer readable medium for storing computer code executable by a processor incorporated in an electronic device for updating audio processing of a programmable hearing aid in communication with the electronic device, comprising:
computer code for identifying a hearing aid setting, the hearing aid setting corresponding to the updated audio processing;
computer code for requesting a review of the identified hearing aid setting;
computer code for receiving the review of the requested hearing aid setting when the review is available;
computer code for requesting the identified hearing aid setting;
computer code for receiving the requested hearing aid setting;
computer code for using the received hearing aid setting to update the audio processing of the programmable hearing aid; and
computer code for processing ambient sound received at the programmable hearing aid in accordance with the updated audio processing.

15. The computer readable medium as recited in claim 14, wherein the electronic device is a portable communication device in wireless communication with the programmable hearing aid, the computer readable medium further comprising:
computer code for presenting a user interface comprising at least a user selectable icon associated with at least one hearing aid setting at a display of the portable communication device;
computer code for receiving a selection event at the user selectable icon; and
computer code for using the selection event to identify the hearing aid setting.

16. The computer readable medium as recited in claim 15, wherein the received review includes at least a commentary portion and a rating portion each provided by a previous user of the hearing aid setting, and wherein the hearing aid setting is requested only when the received review indicates that the updated hearing aid setting is acceptable based upon the commentary portion and the rating portion.

17. The computer readable medium as recited in claim 16, further comprising:
computer code for receiving an external audio signal at an input transducer of the programmable hearing aid;
computer code for processing the external audio signal by a signal processor in accordance with the updated audio processing; and
computer code for outputting the processed external audio signal as an output signal.

18. The computer readable medium as recited in claim 17, further comprising:
computer code for evaluating the output signal by a current user of the hearing aid;
computer code for providing a current review of the received hearing aid setting based upon the evaluation; and
computer code for providing the current review to at least one other hearing aid user in communication with the current hearing aid user.

19. A hearing aid user social network, comprising:
at least a first member and a second member, wherein the first and second members are in communication with each other by way of a first and second communication device, respectively, wherein the first member is associated with a first member identification that uniquely identifies the first member and wherein the second member is associated with a second member identification that uniquely identifies the second member, wherein the first member receives a selected hearing aid setting from the second member by a processor in the first communication device executing the following operations:
identifying the selected hearing aid setting;
confirming a communication channel between the first communication device and the second communication device;
requesting identification of the second member using the communication channel;
receiving identification of the second member;
forwarding a request for the selected hearing aid setting from the first communication device to the second communication device only when the identification of the second member is confirmed;
receiving the selected hearing aid setting; and
using the received hearing aid setting to update operations of the hearing aid.

20. The network as recited in claim 19, wherein the first communication device is located at an event.

21. The network as recited in claim 20, wherein the requested hearing aid setting is associated with an event based hearing aid setting.

22. The network as recited in claim 19, wherein at least a portion of the network is a wireless peer to peer network.

23. The network as recited in claim 19, wherein the network is a server network.
